(19) United States
(12) Patent Application Publication
(10) Pub. No.: US 2010/0330273 A1
(43) Pub. Date: Dec. 30, 2010

(54) SUBSTRATE PROCESSING APPARATUS AND SUBSTRATE PROCESSING METHOD FOR HEAT-TREATING SUBSTRATE

(75) Inventors: Yasuhiro SHIBA, Kamigyo-ku (JP); Yasunori KUBO, Kamigyo-ku (JP); Takuya WADA, Kamigyo-ku (JP)

Correspondence Address: OSTROLENK FABER GERB & SOFFEN, 1180 AVENUE OF THE AMERICAS, NEW YORK, NY, 100368403, US

(73) Assignee: Dainippon Screen Mfg. Co., Ltd.

(21) Appl. No.: 12/879,246

(22) Filed: Sep. 10, 2010

Related U.S. Application Data
(62) Division of application No. 11/775,742, filed on Jul. 10, 2007.

(30) Foreign Application Priority Data
Jul. 10, 2006 (JP) 2006-189195
Sep. 11, 2006 (JP) 2006-245512

(51) Int. Cl. B05D 5/06; B05D 3/02

(52) U.S. Cl. 427/162; 427/226; 427/227

(57) ABSTRACT

A substrate coated with a coating solution for an anti-reflective film is placed on a heat treatment plate and is heated. Nitrogen gas flows near the periphery of the heat treatment plate into a heat treatment space. An exhaust outlet is formed in an upper central portion of an inner cover, and the inner cover has an inner wall surface configured in the form of a tapered surface. This produces a smooth flow of nitrogen gas along the tapered surface to smoothly discharge a sublimate produced from the coating solution together with the gas flow outwardly through the exhaust outlet. After the heating process for a predetermined period of time is completed, the cover moves upwardly, and support pins move upwardly to thrust up the substrate from the heat treatment plate, thereby spacing the substrate apart from the heat treatment plate. This gradually decreases the temperature of the substrate. The substrate is placed in a standby condition within a hot plate in this state until the substrate temperature is decreased down to at least a temperature at which the production of the sublimate from the anti-reflective film after firing stops, and thereafter a transport robot transports the substrate out of the hot plate.

### BACKGROUND OF THE INVENTION

1. Field of the Invention

The present invention relates to a substrate processing apparatus and a substrate processing method for heat-treating a substrate, such as a semiconductor substrate, a glass substrate for a liquid crystal display device, a glass substrate for a photomask, a substrate for an optical disk and the like, to form a predetermined film thereon and, more particularly, to form an anti-reflective film and a carbon film which produce a sublimate during firing.

2. Description of the Background Art

Semiconductor device products, liquid crystal display products and the like are fabricated by performing a series of processes including cleaning, resist coating, exposure, development, etching, interlayer insulation film formation, heat treatment, dicing and the like on the above-mentioned substrate. With the rapid progress of fine patterning in recent years, the wavelength of exposure light for use in the exposure step is becoming shorter, and dominant exposure light is shifting from conventional ultraviolet light known as g-line and i-line toward KrF excimer laser light (having a wavelength of 248 nm) and ArF excimer laser light (having a wavelength of 193 nm). For an exposure process using such excimer laser light, a film of chemically amplified resist is formed on the substrate.

However, the exposure process using the excimer laser light directed onto the substrate with a film of chemically amplified resist formed thereon causes a more significant influence (or standing wave effect) of the reflection from the bottom than the conventional exposure process (using the g-line and i-line). To reduce the influence of the reflection, it has been common practice to form an anti-reflective film on the substrate. In particular, an anti-reflective film formed under the resist film is referred to as a BARC (Bottom Anti-Reflective Coating).

For the formation of the BARC on the substrate, a coating solution for the BARC is applied uniformly onto the substrate by a spin coating method and the like, and then a heating process is performed on the substrate to form an anti-reflective film by firing on the substrate. During the heating process, a resin component in the coating solution sublimes. As a result, a large amount of sublimate is included in an exhaust gas. There is apprehension that such a sublimate is deposited in an exhaust pipe to cause clogging or to become a source of contamination. To avoid this, Japanese Patent Application Laid-Open No. 2005-64277 discloses a technique in which heating an exhaust pipe extending from a heat treatment unit prevents a sublimate from being deposited.

However, a significantly large amount of sublimate is produced especially from the coating solution for the BARC. Thus, even if the sublimate is prevented from being deposited in the exhaust pipe as disclosed in Japanese Patent Application Laid-Open No. 2005-64277, there arises a problem such that the sublimate adheres to the interior and periphery of the heat treatment unit to become a source of contamination. Such a source of contamination cannot be left unremoved. It is hence necessary to perform frequent maintenance (cleaning) of the heat treatment unit for processing the BARC. This results in a significant decrease in operational efficiency of the apparatus.

A conceivable countermeasure to prevent the sublimate from adhering to the interior and exterior of the heat treatment unit includes increasing the amount of gas supplied to and exhausted from the unit to thereby cause a large amount of airflow resulting therefrom to discharge the sublimate outwardly. However, the production of the strong airflow within the unit presents another problem such that the temperature uniformity of the substrate during heating is impaired. It is hence difficult to effectively suppress the adhesion of the sublimate to the heat treatment unit for processing the BARC.

Oftentimes, the heat treatment unit for performing the firing process on the BARC is incorporated in a substrate processing apparatus (what is called a coater-and-developer) for performing a resist coating process and a development process. The production of the sublimate from the BARC continues for some period of time after the end of the firing process in the heat treatment unit. Transporting the substrate subjected to the firing process out of the heat treatment unit for the transport thereof to the next step causes the sublimate to fly off in the substrate processing apparatus. When such a flying sublimate enters, for example, a development processing unit, the sublimate gives rise to a development defect.

To meet requirements for the fine patterning process in recent years, a technique has been developed in which a spin-on-carbon film (or an SOC film) is formed under the resist film and is used as an etching mask. For the formation of such an SOC film, a chemical solution for the SOC film is applied onto the substrate, and then a heating process is performed to form the SOC film by firing on the substrate. It is known that the firing process of the SOC film produces a greater amount of sublimate than the firing process of the above-mentioned BARC. Thus, transporting the substrate subjected to the firing process of the SOC film out of the heat treatment unit for the transport thereof to the next step presents a problem resulting from the flying of the sublime which is as serious as or more serious than that with the firing process of the above-mentioned BARC.

### SUMMARY OF THE INVENTION

The present invention is intended for a substrate processing apparatus for heating a substrate to perform a film formation process on the substrate.

According to the present invention, the substrate processing apparatus comprises: a heat treatment plate having a holding surface for performing a heating process on a substrate placed on the holding surface; a cover positioned over the heat treatment plate during the heating process, the cover including an inner cover opposed to the heat treatment plate, and an outer cover provided so as to cover the inner cover, the inner cover having an inner wall surface opposed to the heat treatment plate, the inner wall surface being configured in the form of a tapered surface; a gas supply element for supplying a predetermined gas to a heat treatment space surrounded by the inner wall surface of the inner cover and the heat treatment plate during the heating process, the gas supply element supplying the predetermined gas so that the predetermined gas passes through a gap formed between the inner cover and the outer cover and then passes near a peripheral portion of the heat treatment plate into the heat treatment space; and an exhaust element for exhausting a gas from the heat treatment space.

The gas supplied from the gas supply element smoothly flows along the inner wall surface of the inner cover, and a sublimate produced from the substrate is smoothly carried by the gas flow outwardly toward the exhaust element. Therefore, the substrate processing apparatus is capable of sufficiently collecting the sublimate produced from a coating solution to suppress the adhesion of the sublimate to the substrate processing apparatus.

According to an aspect of the present invention, the substrate processing apparatus comprises: a coating processing part for coating a substrate with a chemical solution; a heating part for heating the substrate coated with the chemical solution to form a film on the substrate by firing, the heating part including a heat treatment plate having a holding surface for performing a heating process on the substrate placed on the holding surface, and a spacing mechanism for spacing the substrate placed on the holding surface of the heat treatment plate apart from the holding surface; and a transport element for transporting the substrate between the coating processing part and the heating part, the transport element transporting the substrate out of the heating part when the temperature of the substrate subjected to the heating process by the heat treatment plate and then spaced apart from the holding surface by the spacing mechanism is decreased down to at least a predetermined temperature within the heating part.

Preferably, the chemical solution is a liquid producing a sublimate when heated by the heat treatment plate, and the predetermined temperature is a temperature at which the production of the sublimate from the film formed by firing on the substrate stops.

The production of the sublimate from the substrate is stopped at the time of the transport of the substrate out of the heating part. This prevents the sublimate from flying off in the substrate processing apparatus.

The present invention is also intended for a substrate processing method for performing a film formation process on a substrate.

According to the present invention, the substrate processing method comprises the steps of: coating a substrate with a chemical solution in a coating processing part; transporting the substrate coated with the chemical solution from the coating processing part to a heating part; placing the substrate coated with the chemical solution on a holding surface of a heat treatment plate within the heating part and heating the substrate to thereby form a film by firing on the substrate; spacing the substrate subjected to the heating process by the heat treatment plate apart from the holding surface; placing the substrate in a standby condition within the heating part until the temperature of the substrate spaced apart from the holding surface is decreased down to at least a predetermined temperature; and transporting the substrate the temperature of which is decreased down to at least the predetermined temperature out of the heating part.

It is therefore an object of the present invention to provide a substrate processing apparatus capable of sufficiently collecting a sublimate produced from a coating solution to prevent the sublimate from adhering to the substrate processing apparatus.

It is another object of the present invention to provide a substrate processing apparatus and a substrate processing method capable of preventing a sublimate from flying off in the substrate processing apparatus.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a plan view of a substrate processing apparatus according to the present invention;

FIG. 2 is a front view of a liquid processing part in the substrate processing apparatus;

FIG. 3 is a front view of a heat treatment part in the substrate processing apparatus;

FIG. 4 is a view showing a construction around substrate rest parts in the substrate processing apparatus;

FIG. 5A is a plan view of a transport robot;

FIG. 5B is a front view of the transport robot;

FIG. 6 is a block diagram schematically showing a control mechanism in the substrate processing apparatus; and

FIGS. 7 and 8 are side sectional views schematically showing the construction of a hot plate.

### DESCRIPTION OF THE PREFERRED EMBODIMENTS

A preferred embodiment according to the present invention will now be described in detail with reference to the drawings.

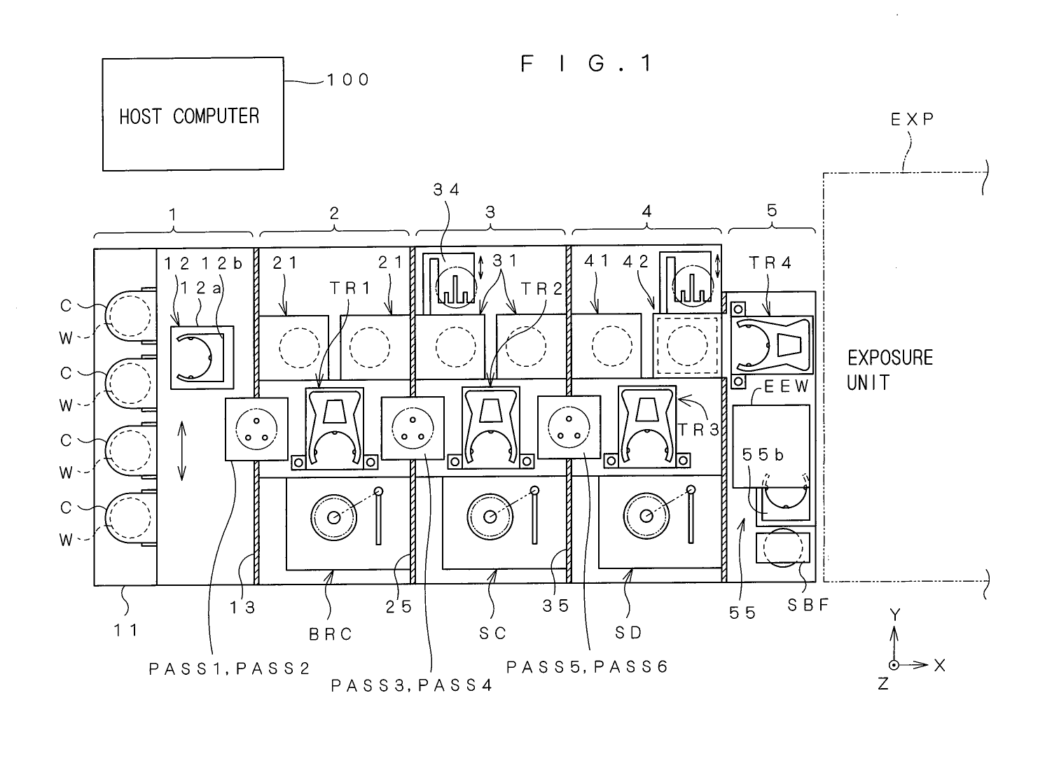

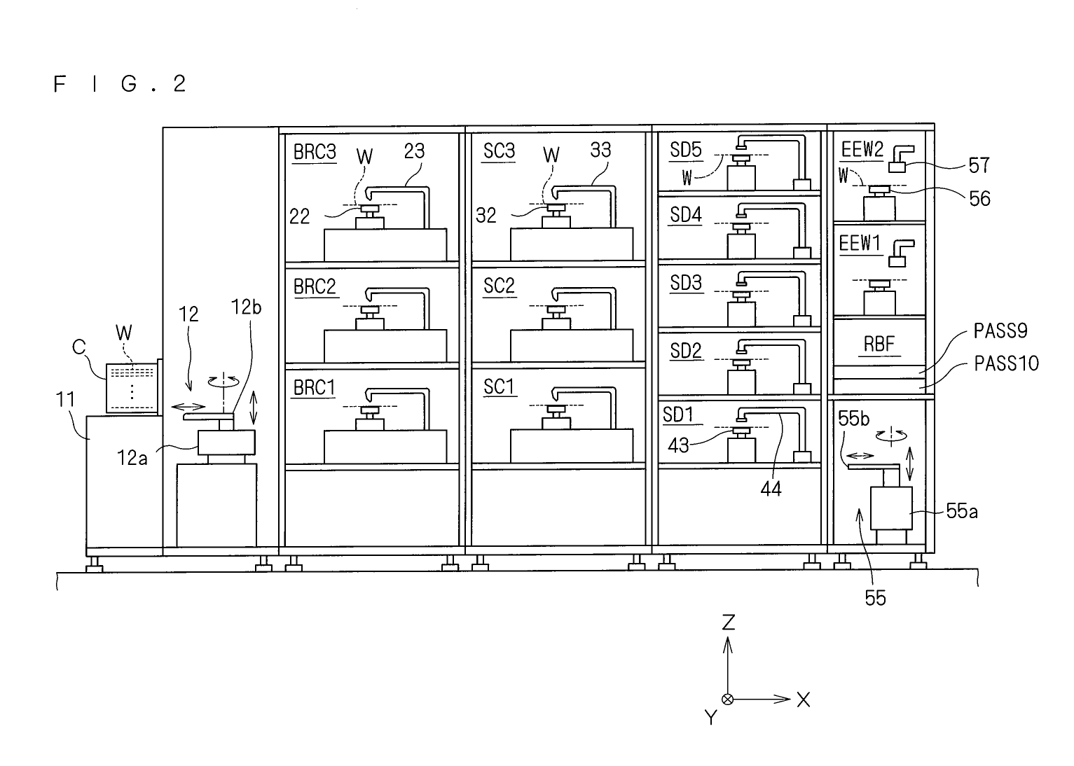

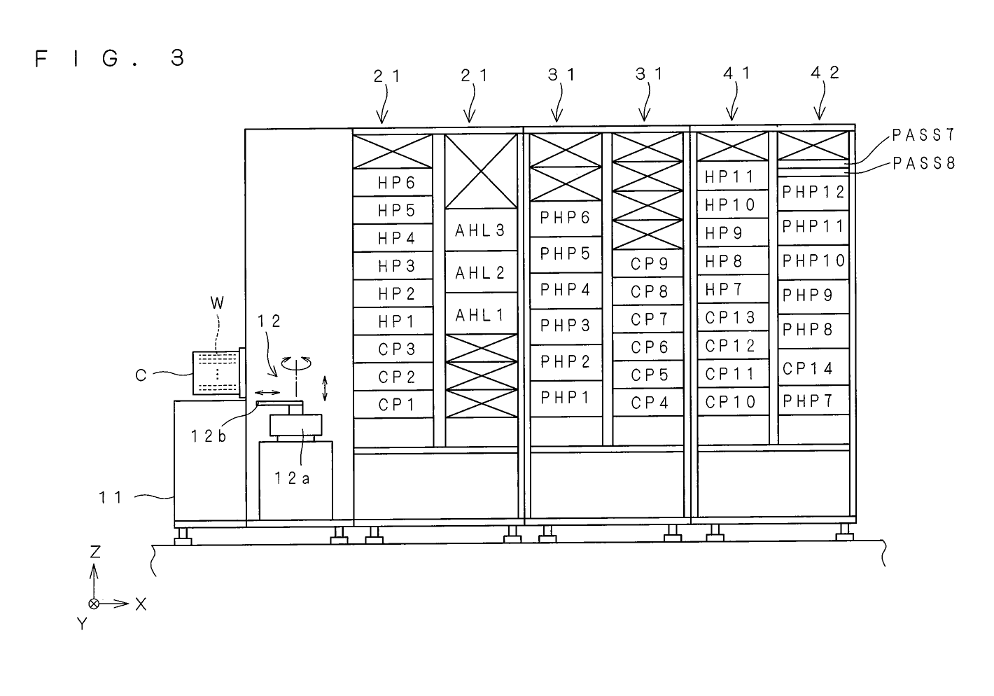

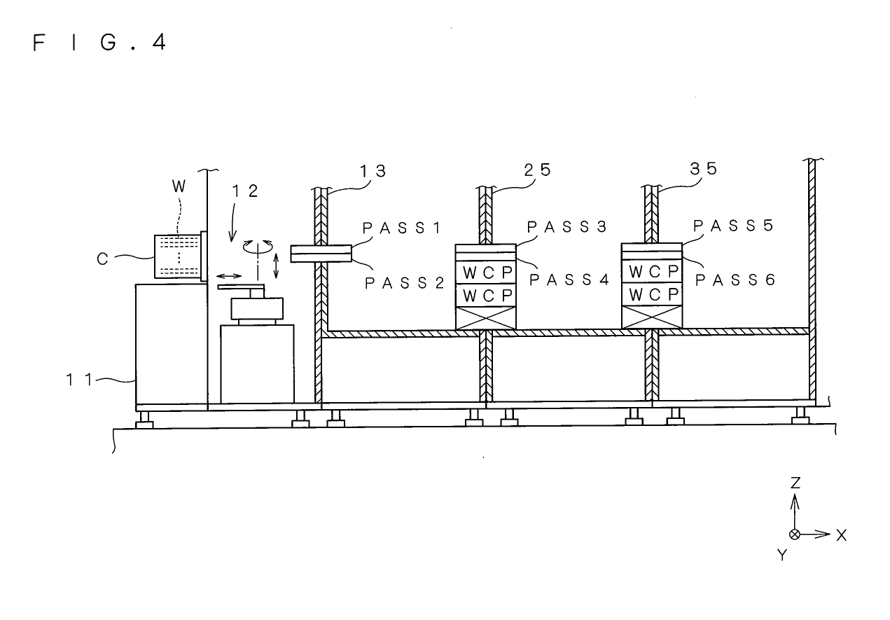

FIG. 1 is a plan view of a substrate processing apparatus according to the present invention. FIG. 2 is a front view of a liquid processing part in the substrate processing apparatus. FIG. 3 is a front view of a heat treatment part in the substrate processing apparatus. FIG. 4 is a view showing a construction around substrate rest parts in the substrate processing apparatus. An XYZ rectangular coordinate system in which an XY plane is defined as the horizontal plane and a Z axis is defined to extend in the vertical direction is additionally shown in FIGS. 1 through 4 for purposes of clarifying the directional relationship therebetween.

The substrate processing apparatus according to the preferred embodiment is an apparatus for forming an anti-reflective film and a photoresist film on substrates such as semiconductor wafers by coating and for performing a development process on substrates subjected to a pattern exposure process. The substrates to be processed by the substrate processing apparatus according to the present invention are not limited to semiconductor wafers, but may include glass substrates for a liquid crystal display device, and the like.

The substrate processing apparatus according to the preferred embodiment includes an indexer block 1, a BARC (Bottom Anti-Reflective Coating) block 2, a resist coating block 3, a development processing block 4, and an interface block 5. In the substrate processing apparatus, the five processing blocks 1 to 5 are arranged in side-by-side relation. An exposure unit (or stepper) EXP which is an external apparatus separate from the substrate processing apparatus according to the present invention is provided and connected to the interface block 5. The substrate processing apparatus according to this preferred embodiment and the exposure unit EXP are connected via LAN lines (not shown) to a host computer 100.

The indexer block 1 is a processing block for transferring unprocessed substrates received from the outside of the substrate processing apparatus outwardly to the BARC block 2 and the resist coating block 3, and for transporting processed substrates received from the development processing block 4 outwardly to the outside of the substrate processing apparatus. The indexer block 1 includes a table 11 for placing thereon a plurality of (in this preferred embodiment, four) cassettes (or carriers) C in juxtaposition, and a substrate transfer mechanism 12 for taking an unprocessed substrate W out of each of the cassettes C and for storing a processed substrate W into each of the cassettes C. The substrate transfer mechanism 12 includes a movable base 12a movable horizontally (in the Y direction) along the table 11, and a holding arm 12b mounted on the movable base 12a and for holding a substrate W in a horizontal position. The holding arm 12b is capable of moving vertically (in the Z direction) over the movable base 12a, pivoting within a horizontal plane and moving back and forth in the direction of the pivot radius. Thus, the substrate transfer mechanism 12 can cause the holding arm 12b to gain access to each of the cassettes C, thereby taking an unprocessed substrate W out of each cassette C and storing a processed substrate W into each cassette C. The cassettes C may be of the following types: an SMIF (standard mechanical interface) pod, and an OC (open cassette) which exposes stored substrates W to the atmosphere, in addition to a FOUP (front opening unified pod) which stores substrates W in an enclosed or sealed space.

The BARC block 2 is provided in adjacent relation to the indexer block 1. A partition 13 for closing off the communication of atmosphere is provided between the indexer block 1 and the BARC block 2. The partition 13 is provided with a pair of vertically arranged substrate rest parts PASS1 and PASS2 each for placing a substrate W thereon for the transfer of the substrate W between the indexer block 1 and the BARC block 2.

The upper substrate rest part PASS1 is used for the transport of a substrate W from the indexer block 1 to the BARC block 2. The substrate rest part PASS1 includes three support pins. The substrate transfer mechanism 12 of the indexer block 1 places an unprocessed substrate W taken out of one of the cassettes C onto the three support pins of the substrate rest part PASS1. A transport robot TR1 of the BARC block 2 to be described later receives the substrate W placed on the substrate rest part PASS1. The lower substrate rest part PASS2, on the other hand, is used for the transport of a substrate W from the BARC block 2 to the indexer block 1. The substrate rest part PASS2 also includes three support pins. The transport robot TR1 of the BARC block 2 places a processed substrate W onto the three support pins of the substrate rest part PASS2. The substrate transfer mechanism 12 receives the substrate W placed on the substrate rest part PASS2 and stores the substrate W into one of the cassettes C. Pairs of substrate rest parts PASS3 to PASS10 to be described later are similar in construction to the pair of substrate rest parts PASS1 and PASS2.

The substrate rest parts PASS1 and PASS2 extend through the partition 13. Each of the substrate rest parts PASS1 and PASS2 includes an optical sensor (not shown) for detecting the presence or absence of a substrate W thereon. Based on a detection signal from each of the sensors, a judgment is made as to whether or not the substrate transfer mechanism 12 and the transport robot TR1 of the BARC block 2 stand ready to transfer and receive a substrate W to and from the substrate rest parts PASS1 and PASS2.

Next, the BARC block 2 will be described. The BARC block 2 is a processing block for forming an anti-reflective film by coating at the bottom of a photoresist film (i.e., as an undercoating film for the photoresist film), that is, for forming a BARC on a substrate W to reduce the influence of reflection (a standing wave effect and halation) occurring during exposure. The BARC block 2 includes a bottom coating processor BRC for coating the surface of a substrate W with a chemical solution serving as a coating solution for the formation of the anti-reflective film, a pair of heat treatment towers 21 for performing a heat treatment which accompanies the formation of the anti-reflective film by coating, and the transport robot TR1 for transferring and receiving a substrate W to and from the bottom coating processor BRC and the pair of heat treatment towers 21.

In the BARC block 2, the bottom coating processor BRC and the pair of heat treatment towers 21 are arranged on opposite sides of the transport robot TR1. Specifically, the bottom coating processor BRC is on the front side of the substrate processing apparatus, and the pair of heat treatment towers 21 are on the rear side thereof. Additionally, a thermal barrier not shown is provided on the front side of the pair of heat treatment towers 21. Thus, the thermal effect of the pair of heat treatment towers 21 upon the bottom coating processor BRC is avoided by spacing the bottom coating processor BRC apart from the pair of heat treatment towers 21 and by providing the thermal barrier.

As shown in FIG. 2, the bottom coating processor BRC includes three coating processing units BRC1, BRC2 and BRC3 similar in construction to each other and arranged in stacked relation in bottom-to-top order. The three coating processing units BRC1, BRC2 and BRC3 are collectively referred to as the bottom coating processor BRC, unless otherwise identified. Each of the coating processing units BRC1, BRC2 and BRC3 includes a spin chuck 22 for rotating a substrate W in a substantially horizontal plane while holding the substrate W in a substantially horizontal position under suction, a coating nozzle 23 for applying the chemical solution serving as the coating solution for the anti-reflective film onto the substrate W held on the spin chuck 22, a spin motor (not shown) for rotatably driving the spin chuck 22, a cup (not shown) surrounding the substrate W held on the spin chuck 22, and the like.

As shown in FIG. 3, one of the heat treatment towers 21 which is closer to the indexer block 1 includes six hot plates HP1 to HP6 for heating a substrate W up to a predetermined temperature, and cool plates CP1 to CP3 for cooling a heated substrate W down to a predetermined temperature and maintaining the substrate W at the predetermined temperature. The cool plates CP1 to CP3 and the hot plates HP1 to HP6 are arranged in stacked relation in bottom-to-top order in this heat treatment tower 21. The other of the heat treatment towers 21 which is farther from the indexer block 1 includes three adhesion promotion processing parts AHL1 to AHL3 arranged in stacked relation in bottom-to-top order for heat-treating a substrate W in a vapor atmosphere of HMDS (hexamethyl disilazane) to promote the adhesion of the resist film to the substrate W. The locations indicated by the cross marks (x) in FIG. 3 are occupied by a piping and wiring section or reserved as empty space for future addition of processing units.

Thus, stacking the coating processing units BRC1 to BRC3 and the heat treatment units (the hot plates HP1 to HP6, the cool plates CP1 to CP3, and the adhesion promotion processing parts AHL1 to AHL3 in the BARC block 2) in tiers provides smaller space occupied by the substrate processing apparatus to reduce the footprint thereof. The side-by-side arrangement of the pair of heat treatment towers 21 is advantageous in facilitating the maintenance of the heat treatment units and in eliminating the need for extension of ducting and power supply equipment necessary for the heat treatment units to a much higher position.

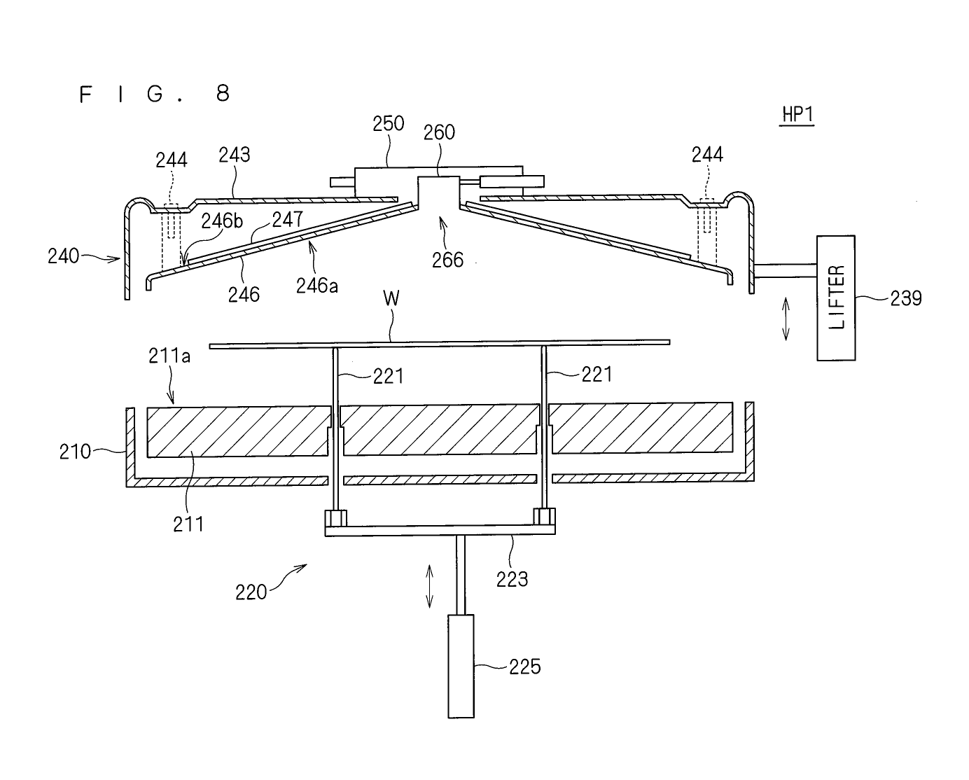

Each of the above-mentioned hot plates HP1 to HP6 is a heat treatment unit for heating a substrate W coated with the coating solution for the anti-reflective film in the bottom coating processor BRC to form the anti-reflective film on the substrate W by firing. FIGS. 7 and 8 are side sectional views schematically showing the construction of the hot plate HP1. Although only the hot plate HP1 is described herein, the hot plates HP2 to HP6 are completely identical with the hot plate HP1. The hot plate HP1 includes a lower chamber 210 having a heat treatment plate 211, and a cover 240 constructed as an upper chamber.

The heat treatment plate 211 is a disc-shaped heater having a holding surface 211a for performing a heating process on the substrate W placed on the holding surface 211a, and is constructed by, for example, a mica heater including a resistance heating element sandwiched between mica plates. A plurality of (e.g., three) ceramic balls (not shown) constructed by a member made of alumina (Al₂O₃) and the like are provided on the surface of the heat treatment plate 211. The ceramic balls are provided in such a manner that upper ends of the respective ceramic balls protrude a slight distance from the surface of the heat treatment plate 211. When the substrate W is placed on the holding surface 211a of the heat treatment plate 211, a slight space known as what is called a proximity gap is formed between the substrate W and the holding surface 211a. The ceramic balls may be dispensed with so that the substrate W is directly placed on the holding surface 211a of the heat treatment plate 211 in surface contacting relationship.

The lower chamber 210 receiving the heat treatment plate 211 is provided with a thrusting-up mechanism 220 for placing the substrate W on the holding surface 211a and for thrusting the substrate W upwardly from the holding surface 211a to space the substrate W apart from the holding surface 211a. The thrusting-up mechanism 220 includes a plurality of (in this preferred embodiment, three) support pins 221, a support plate 223, and an air cylinder 225. The three support pins 221 are fixed and mounted upright on the support plate 223. The support plate 223 is coupled to a piston included in the air cylinder 225, and is driven by the air cylinder 225 to move upwardly and downwardly. The heat treatment plate 211 and the bottom plate of the lower chamber 210 are provided with through holes sized to allow the support pins 221 to pass therethrough, and the air cylinder 225 drives the three support pins 221 to move upwardly and downwardly through the through holes. As the air cylinder 225 moves the support plate 223 upwardly and downwardly, the three support pins 221 mounted upright on the support plate 223 move upwardly and downwardly in unison.

The three support pins 221 are driven by the air cylinder 225 to move upwardly and downwardly between a processing position shown in FIG. 7 and a standby position shown in FIG. 8. As shown in FIG. 7, when the support pins 221 are moved down to the processing position, the upper ends of the respective support pins 221 are hidden inside the through holes of the heat treatment plate 211. As shown in FIG. 8, on the other hand, when the support pins 221 are moved up to the standby position, the upper ends of the respective support pins 221 protrude from the holding surface 211a of the heat treatment plate 211.

The cover 240 is positioned over the heat treatment plate 211 during the heating process of the substrate W to increase heating efficiency and to collect a sublimate (or a volatile material) from the coating solution for the anti-reflective film, thereby preventing the sublimate (or the volatile material) from diffusing to the outside of the unit of the hot plate HP1. The entire cover 240 is of a cylindrical shape with an open lower portion, and has a double-layer structure composed of an outer cover 243 and an inner cover 246.

A gas supply and exhaust block 250 is fixedly provided over the central portion of the outer surface of the outer cover 243. The gas supply and exhaust block 250 is connected in communication with a gas supply source 255 through a gas supply pipe 251. A gas supply valve 252 and a flow regulating valve 253 are inserted in the gas supply pipe 251. The gas supply source 255 is capable of supplying various processing gases (for example, an inert gas including nitrogen (N₂) gas, helium (He) gas, argon (Ar) gas and the like, or oxygen (O₂) gas and the like). In this preferred embodiment, the gas supply source 255 supplies nitrogen gas. The gas supply valve 252 is an on-off valve. The flow regulating valve 253 is a valve for regulating the rate of flow of the nitrogen gas passing through the gas supply pipe 251. By opening the gas supply valve 252, the nitrogen gas is fed from the gas supply source 255 through the gas supply pipe 251 to the gas supply and exhaust block 250, and the rate of flow of the nitrogen gas is controlled by the flow regulating valve 253.

An exhaust port 260 is provided inside the gas supply and exhaust block 250. The exhaust port 260 is connected in communication with an exhaust part 265 through an exhaust pipe 261. An exhaust valve 262 and a flow regulating valve 263 are inserted in the exhaust pipe 261. For example, an exhaust pump may be provided as the exhaust part 265 in the substrate processing apparatus. Alternatively, a factory exhaust utility system outside the substrate processing apparatus may be used as the exhaust part 265. The exhaust valve 262 is an on-off valve. The flow regulating valve 263 is a valve for regulating the rate of flow of the exhaust gas passing through the exhaust pipe 261. By opening the exhaust valve 262 while the exhaust part 265 is operated, a negative pressure is exerted on the exhaust port 260 to cause an atmosphere surrounding the exhaust port 260 to be exhausted through the exhaust pipe 261, and the rate of flow of the exhaust gas is controlled by the flow regulating valve 263.

The inner cover 246 is mounted to the outer cover 243 by a plurality of (for example, six) bosses 244. A gap is formed between the inner cover 246 and the outer cover 243. The outer cover 243 is upwardly and downwardly movable by a lifter 239. As the outer cover 243 moves upwardly and downwardly, the inner cover 246 mounted to the outer cover 243 moves upwardly and downwardly integrally with the outer cover 243. That is, the lifter 239 moves the entire cover 240 upwardly and downwardly between the processing position shown in FIG. 7 and the standby position shown in FIG. 8. Various known mechanisms such as, for example, an air cylinder and a belt drive mechanism may be employed as the lifter 239. Portions of the gas supply pipe 251 and the exhaust pipe 261 which are adjacent to at least the gas supply and exhaust block 250 are constructed by using a flexible tube and the like so that the cover 240 is upwardly and downwardly movable.

When the cover 240 is moved down to the processing position shown in FIG. 7 by the lifter 239, a heat treatment space 230 is formed which is surrounded by the inner surface of the inner cover 246 and the holding surface 211a of the heat treatment plate 211. That is, the inner cover 246 is in direct contact with the heat treatment space 230. In this preferred embodiment, an inner wall surface 246a of the inner cover 246 which is in contact with the heat treatment space 230 is a tapered surface. Specifically, an exhaust outlet 266 is formed in a central portion of the inner cover 246, and the inner wall surface 246a of the inner cover 246 is a tapered surface such as to flare out from the exhaust outlet 266 toward the heat treatment plate 211 (i.e., to have a diameter increasing toward the bottom).

The inner cover 246 is made of stainless steel excellent in strength and in heat resistance. The inner wall surface 246a of the inner cover 246 is mirror-finished by electrolytic polishing, and has an average surface roughness (Ra) of not greater than 1.6 μm. A heater 247 is affixed to an outer wall surface 246b of the inner cover 246 which is opposed to the outer cover 243. A heater of a planar configuration such as, for example, a silicone rubber heater is used as the heater 247.

On the other hand, the outer cover 243 provided to cover the inner cover 246 is also made of stainless steel. The outer cover 243 is a member for principally lessening heat dissipation from the inner cover 246 to the outside. An opening is formed in an upper central portion of the outer cover 243, and the gas supply and exhaust block 250 is mounted to the outer cover 243 so as to cover the opening. The exhaust port 260 separates the atmosphere inside the gas supply and exhaust block 250 from the atmosphere outside the gas supply and exhaust block 250. Specifically, the exhaust outlet 266 is covered with the exhaust port 260, and a first portion of the interior space of the gas supply and exhaust block 250 which is inside the exhaust port 260 serves as an exhaust path whereas a second portion of the interior space of the gas supply and exhaust block 250 which is outside the exhaust port 260 serves as a gas supply path. The atmosphere in the first portion and the atmosphere in the second portion are shut off from each other.

The second portion of the interior space of the gas supply and exhaust block 250 which is outside the exhaust port 260 is connected in communication with the gas supply pipe 251, and is also in communication with the gap defined between the inner cover 246 and the outer cover 243 through the central opening of the outer cover 243. Thus, the nitrogen gas fed from the gas supply source 255 through the gas supply pipe 251 to the gas supply and exhaust block 250 flows through the central opening of the outer cover 243 (more exactly, a portion of the central opening which is around the exhaust port 260) into the gap defined between the inner cover 246 and the outer cover 243. The nitrogen gas further flows along the gap, and passes near a peripheral portion of the cover 240 into the heat treatment space 230. The gap between the inner cover 246 and the outer cover 243 extends from the central opening of the outer cover 243 to the peripheral portion of the cover 240. Part of the gap between the inner cover 246 and the outer cover 243 which is positioned near the peripheral portion of the cover 240 functions as an annular gas supply opening.

The nitrogen gas passing near the peripheral portion of the cover 240 flows into the heat treatment space 230 and then flows from a peripheral portion of the heat treatment plate 211 toward a central portion thereof (i.e., from an outer peripheral portion of the substrate W being heat-treated toward a central portion thereof). The nitrogen gas flowing into the heat treatment space 230 passes through the exhaust outlet 266 formed in the upper central portion of the inner cover 246 and is collected by the exhaust port 260. Then, the nitrogen gas passes through the exhaust pipe 261 and is discharged into the exhaust part 265. A supply gas flow and an exhaust gas flow are not mixed together because the exhaust port 260 separates the atmosphere inside the gas supply and exhaust block 250 and the atmosphere outside the gas supply and exhaust block 250 from each other. In the hot plate HP1, the lower chamber 210 and the cover 240 are housed in an enclosure (not shown) provided with a shutter to be accessed by the transport robot TR1. The atmosphere in the hot plate HP1 as the entire unit is separated from the atmosphere near the transport robot TR1.

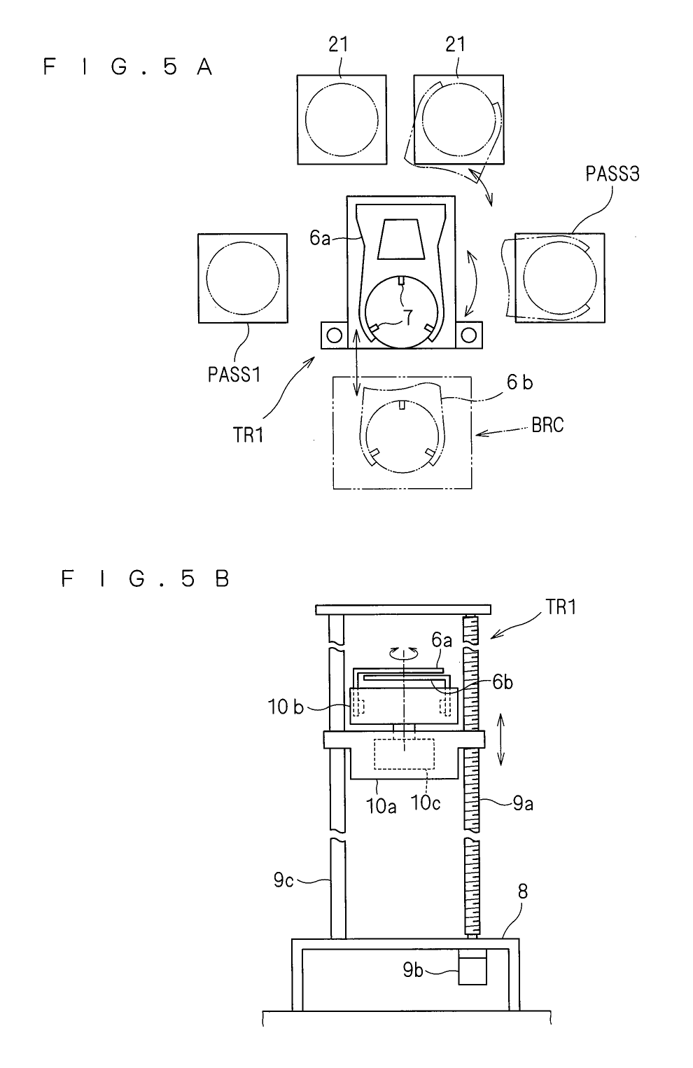

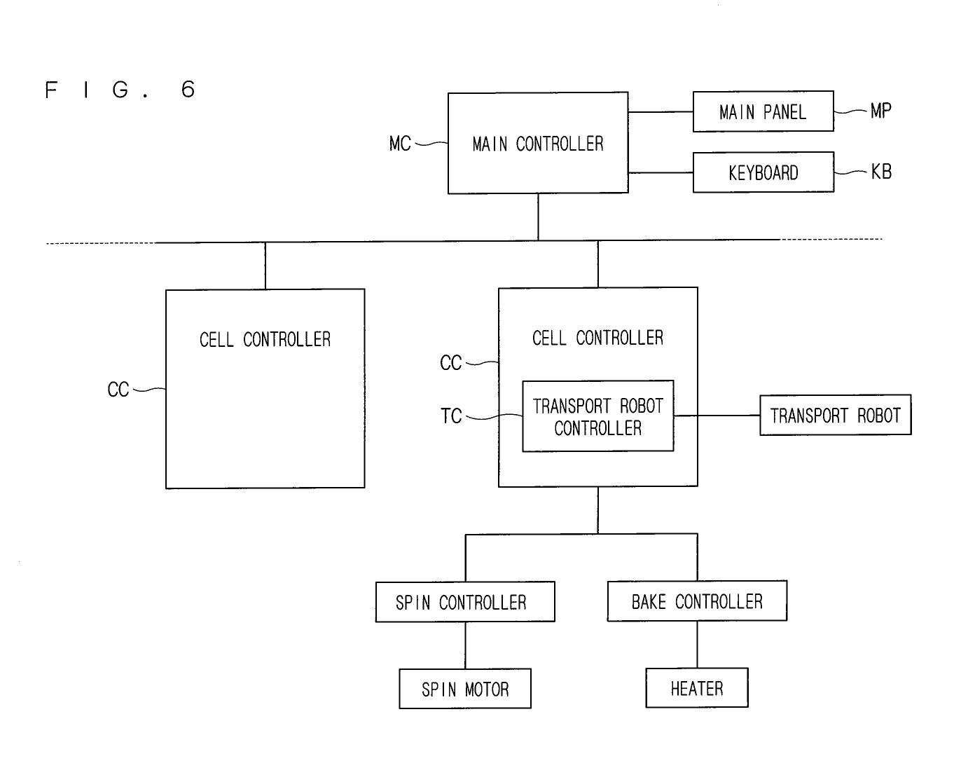

FIGS. 5A and 5B are views for illustrating the transport robot TR1. FIG. 5A is a plan view of the transport robot TR1, and FIG. 5B is a front view of the transport robot TR1. The transport robot TR1 includes a pair of (upper and lower) holding arms 6a and 6b in proximity to each other for holding a substrate W in a substantially horizontal position. Each of the holding arms 6a and 6b includes a distal end portion of a substantially C-shaped plan configuration, and a plurality of pins 7 projecting inwardly from the inside of the substantially C-shaped distal end portion for supporting the peripheral edge of a substrate W from below.

The transport robot TR1 further includes a base 8 fixedly mounted on an apparatus base (or an apparatus frame). A guide shaft 9c is mounted upright on the base 8, and a threaded shaft 9a is rotatably mounted and supported upright on the base 8. A motor 9b for rotatably driving the threaded shaft 9a is fixedly mounted to the base 8. A lift 10a is in threaded engagement with the threaded shaft 9a, and is freely slidable relative to the guide shaft 9c. With such an arrangement, the motor 9b rotatably drives the threaded shaft 9a, whereby the lift 10a is guided by the guide shaft 9c to move up and down in a vertical direction (in the Z direction).

An arm base 10b is mounted on the lift 10a pivotably about a vertical axis. The lift 10a contains a motor 10c for pivotably driving the arm base 10b. The pair of (upper and lower) holding arms 6a and 6b described above are provided on the arm base 10b. Each of the holding arms 6a and 6b is independently movable back and forth in a horizontal direction (in the direction of the pivot radius of the arm base 10b) by a sliding drive mechanism (not shown) mounted to the arm base 10b.

With such an arrangement, the transport robot TR1 is capable of causing each of the pair of holding arms 6a and 6b to independently gain access to the substrate rest parts PASS1 and PASS2, the heat treatment units provided in the heat treatment towers 21, the coating processing units provided in the bottom coating processor BRC, and the substrate rest parts PASS3 and PASS4 to be described later, thereby transferring and receiving substrates W to and from the above-mentioned parts and units, as shown in FIG. 5A.

Next, the resist coating block 3 will be described. The resist coating block 3 is provided so as to be sandwiched between the BARC block 2 and the development processing block 4. A partition 25 for closing off the communication of atmosphere is also provided between the resist coating block 3 and the BARC block 2. The partition 25 is provided with the pair of vertically arranged substrate rest parts PASS3 and PASS4 each for placing a substrate W thereon for the transfer of a substrate W between the BARC block 2 and the resist coating block 3. The substrate rest parts PASS3 and PASS4 are similar in construction to the above-mentioned substrate rest parts PASS1 and PASS2.

The upper substrate rest part PASS3 is used for the transport of a substrate W from the BARC block 2 to the resist coating block 3. Specifically, a transport robot TR2 of the resist coating block 3 receives the substrate W placed on the substrate rest part PASS3 by the transport robot TR1 of the BARC block 2. The lower substrate rest part PASS4, on the other hand, is used for the transport of a substrate W from the resist coating block 3 to the BARC block 2. Specifically, the transport robot TR1 of the BARC block 2 receives the substrate W placed on the substrate rest part PASS4 by the transport robot TR2 of the resist coating block 3.

The substrate rest parts PASS3 and PASS4 extend through the partition 25. Each of the substrate rest parts PASS3 and PASS4 includes an optical sensor (not shown) for detecting the presence or absence of a substrate W thereon. Based on a detection signal from each of the sensors, a judgment is made as to whether or not the transport robots TR1 and TR2 stand ready to transfer and receive a substrate W to and from the substrate rest parts PASS3 and PASS4. A pair of (upper and lower) cool plates WCP of a water-cooled type for roughly cooling a substrate W are provided under the substrate rest parts PASS3 and PASS4 to extend through the partition 25.

The resist coating block 3 is a processing block for applying a resist onto a substrate W coated with the anti-reflective film by the BARC block 2 to form a resist film. In this preferred embodiment, a chemically amplified resist is used as the photoresist. The resist coating block 3 includes a resist coating processor SC for forming the resist film by coating on the anti-reflective film serving as the undercoating film, a pair of heat treatment towers 31 for performing a heat treatment which accompanies the resist coating process, and the transport robot TR2 for transferring and receiving a substrate W to and from the resist coating processor SC and the pair of heat treatment towers 31.

In the resist coating block 3, the resist coating processor SC and the pair of heat treatment towers 31 are arranged on opposite sides of the transport robot TR2. Specifically, the resist coating processor SC is on the front side of the substrate processing apparatus, and the pair of heat treatment towers 31 are on the rear side thereof. Additionally, a thermal barrier not shown is provided on the front side of the pair of heat treatment towers 31. Thus, the thermal effect of the pair of heat treatment towers 31 upon the resist coating processor SC is avoided by spacing the resist coating processor SC apart from the pair of heat treatment towers 31 and by providing the thermal barrier.

As shown in FIG. 2, the resist coating processor SC includes three coating processing units SC1, SC2 and SC3 similar in construction to each other and arranged in stacked relation in bottom-to-top order. The three coating processing units SC1, SC2 and SC3 are collectively referred to as the resist coating processor SC, unless otherwise identified. Each of the coating processing units SC1, SC2 and SC3 includes a spin chuck 32 for rotating a substrate W in a substantially horizontal plane while holding the substrate W in a substantially horizontal position under suction, a coating nozzle 33 for applying a resist solution onto the substrate W held on the spin chuck 32, a spin motor (not shown) for rotatably driving the spin chuck 32, a cup (not shown) surrounding the substrate W held on the spin chuck 32, and the like.

As shown in FIG. 3, one of the heat treatment towers 31 which is closer to the indexer block 1 includes six heating parts PHP1 to PHP6 arranged in stacked relation in bottom-to-top order for heating a substrate W up to a predetermined temperature. The other of the heat treatment towers 31 which is farther from the indexer block 1 includes cool plates CP4 to CP9 arranged in stacked relation in bottom-to-top order for cooling a heated substrate W down to a predetermined temperature and maintaining the substrate W at the predetermined temperature.

Each of the heating parts PHP1 to PHP6 is a heat treatment unit including, in addition to an ordinary hot plate for heating a substrate W placed thereon, a temporary substrate rest part for placing a substrate W in an upper position spaced apart from the hot plate, and a local transport mechanism 34 (see FIG. 1) for transporting a substrate W between the hot plate and the temporary substrate rest part. The local transport mechanism 34 is capable of moving vertically and moving back and forth, and includes a mechanism for cooling down a substrate W being transported by circulating cooling water therein.

The local transport mechanism 34 is provided on the opposite side of the above-mentioned hot plate and the temporary substrate rest part from the transport robot TR2, that is, on the rear side of the substrate processing apparatus. The temporary substrate rest part has both an open side facing the transport robot TR2 and an open side facing the local transport mechanism 34. The hot plate, on the other hand, has only an open side facing the local transport mechanism 34, and a closed side facing the transport robot TR2. Thus, both of the transport robot TR2 and the local transport mechanism 34 can gain access to the temporary substrate rest part, but only the local transport mechanism 34 can gain access to the hot plate.

A substrate W is transported into each of the heating parts PHP1 to PHP6 having such a construction in a manner to be described below. First, the transport robot TR2 places a substrate W onto the temporary substrate rest part. Subsequently, the local transport mechanism 34 receives the substrate W from the temporary substrate rest part to transport the substrate W to the hot plate. The hot plate performs a heating process on the substrate W. The local transport mechanism 34 takes out the substrate W subjected to the heating process by the hot plate, and transports the substrate W to the temporary substrate rest part. During the transport, the substrate W is cooled down by the cooling function of the local transport mechanism 34. Thereafter, the transport robot TR2 takes out the substrate W subjected to the heat treatment and transported to the temporary substrate rest part.

As discussed above, the transport robot TR2 transfers and receives the substrate W to and from only the temporary substrate rest part held at room temperature in each of the heating parts PHP1 to PHP6, but does not directly transfer and receive the substrate W to and from the hot plate. This avoids the temperature rise of the transport robot TR2. The hot plate having only the open side facing the local transport mechanism 34 prevents the heat atmosphere leaking out of the hot plate from affecting the transport robot TR2 and the resist coating processor SC. The transport robot TR2 directly transfers and receives a substrate W to and from the cool plates CP4 to CP9.

The transport robot TR2 is precisely identical in construction with the transport robot TR1. Thus, the transport robot TR2 is capable of causing each of a pair of holding arms thereof to independently gain access to the substrate rest parts PASS3 and PASS4, the heat treatment units provided in the heat treatment towers 31, the coating processing units provided in the resist coating processor SC, and the substrate rest parts PASS5 and PASS6 to be described later, thereby transferring and receiving substrates W to and from the above-mentioned parts and units.

Next, the development processing block 4 will be described. The development processing block 4 is provided so as to be sandwiched between the resist coating block 3 and the interface block 5. A partition 35 for closing off the communication of atmosphere is also provided between the resist coating block 3 and the development processing block 4. The partition 35 is provided with the pair of vertically arranged substrate rest parts PASS5 and PASS6 each for placing a substrate W thereon for the transfer of a substrate W between the resist coating block 3 and the development processing block 4. The substrate rest parts PASS5 and PASS6 are similar in construction to the above-mentioned substrate rest parts PASS1 and PASS2.

The upper substrate rest part PASS5 is used for the transport of a substrate W from the resist coating block 3 to the development processing block 4. Specifically, a transport robot TR3 of the development processing block 4 receives the substrate W placed on the substrate rest part PASS5 by the transport robot TR2 of the resist coating block 3. The lower substrate rest part PASS6, on the other hand, is used for the transport of a substrate W from the development processing block 4 to the resist coating block 3. Specifically, the transport robot TR2 of the resist coating block 3 receives the substrate W placed on the substrate rest part PASS6 by the transport robot TR3 of the development processing block 4.

The substrate rest parts PASS5 and PASS6 extend through the partition 35. Each of the substrate rest parts PASS5 and PASS6 includes an optical sensor (not shown) for detecting the presence or absence of a substrate W thereon. Based on a detection signal from each of the sensors, a judgment is made as to whether or not the transport robots TR2 and TR3 stand ready to transfer and receive a substrate W to and from the substrate rest parts PASS5 and PASS6. A pair of (upper and lower) cool plates WCP of a water-cooled type for roughly cooling a substrate W are provided under the substrate rest parts PASS5 and PASS6 to extend through the partition 35.

The development processing block 4 is a processing block for performing a development process on an exposed substrate W. The development processing block 4 includes a development processor SD for applying a developing solution onto a substrate W exposed in a pattern to perform the development process, a pair of heat treatment towers 41 and 42 for performing a heat treatment which accompanies the development process, and the transport robot TR3 for transferring and receiving a substrate W to and from the development processor SD and the pair of heat treatment towers 41 and 42. The transport robot TR3 is precisely identical in construction to the above-mentioned transport robots TR1 and TR2.

As shown in FIG. 2, the development processor SD includes five development processing units SD1, SD2, SD3, SD4 and SD5 similar in construction to each other and arranged in stacked relation in bottom-to-top order. The five development processing units SD1 to SD5 are collectively referred to as the development processor SD, unless otherwise identified. Each of the development processing units SD1 to SD5 includes a spin chuck 43 for rotating a substrate W in a substantially horizontal plane while holding the substrate W in a substantially horizontal position under suction, a nozzle 44 for applying the developing solution onto the substrate W held on the spin chuck 43, a spin motor (not shown) for rotatably driving the spin chuck 43, a cup (not shown) surrounding the substrate W held on the spin chuck 43, and the like.

As shown in FIG. 3, the heat treatment tower 41 which is closer to the indexer block 1 includes five hot plates HP7 to HP11 for heating a substrate W up to a predetermined temperature, and cool plates CP10 to CP13 for cooling a heated substrate W down to a predetermined temperature and maintaining the substrate W at the predetermined temperature. The cool plates CP10 to CP13 and the hot plates HP7 to HP11 are arranged in stacked relation in bottom-to-top order in this heat treatment tower 41. The heat treatment tower 42 which is farther from the indexer block 1, on the other hand, includes six heating parts PHP7 to PHP12 and a cool plate CP14 which are arranged in stacked relation. Like the above-mentioned heating parts PHP1 to PHP6, each of the heating parts PHP7 to PHP12 is a heat treatment unit including a temporary substrate rest part and a local transport mechanism. However, the temporary substrate rest part of each of the heating parts PHP7 to PHP12 and the cool plate CP14 have an open side facing a transport robot TR4 of the interface block 5, and a closed side facing the transport robot TR3 of the development processing block 4. In other words, the transport robot TR4 of the interface block 5 can gain access to the heating parts PHP7 to PHP12 and the cool plate CP14, but the transport robot TR3 of the development processing block 4 cannot gain access thereto. The transport robot TR3 of the development processing block 4 gains access to the heat treatment units incorporated in the heat treatment tower 41.

The pair of vertically arranged substrate rest parts PASS7 and PASS8 in proximity to each other for the transfer of a substrate W between the development processing block 4 and the interface block 5 adjacent thereto are incorporated in the topmost tier of the heat treatment tower 42. The upper substrate rest part PASS7 is used for the transport of a substrate W from the development processing block 4 to the interface block 5. Specifically, the transport robot TR4 of the interface block 5 receives the substrate W placed on the substrate rest part PASS7 by the transport robot TR3 of the development processing block 4. The lower substrate rest part PASS8, on the other hand, is used for the transport of a substrate W from the interface block 5 to the development processing block 4. Specifically, the transport robot TR3 of the development processing block 4 receives the substrate W placed on the substrate rest part PASS8 by the transport robot TR4 of the interface block 5. Each of the substrate rest parts PASS7 and PASS8 includes both an open side facing the transport robot TR3 of the development processing block 4 and an open side facing the transport robot TR4 of the interface block 5.

Next, the interface block 5 will be described. The interface block 5 is a block provided adjacent to the development processing block 4. The interface block 5 receives a substrate W with the resist film formed thereon by the resist coating process from the resist coating block 3 to transfer the substrate W to the exposure unit EXP which is an external apparatus separate from the substrate processing apparatus according to the present invention. Also, the interface block 5 receives an exposed substrate W from the exposure unit EXP to transfer the exposed substrate W to the development processing block 4. The interface block 5 in this preferred embodiment includes a transport mechanism 55 for transferring and receiving a substrate W to and from the exposure unit EXP, a pair of edge exposure units EEW1 and EEW2 for exposing the periphery of a substrate W formed with the resist film, and the transport robot TR4 for transferring and receiving a substrate W to and from the heating parts PHP7 to PHP12 and the cool plate CP14 which are provided in the development processing block 4 and to and from the edge exposure units EEW1 and EEW2.

As shown in FIG. 2, each of the edge exposure units EEW1 and EEW2 (collectively referred to as an edge exposure part EEW, unless otherwise identified) includes a spin chuck 56 for rotating a substrate W in a substantially horizontal plane while holding the substrate W in a substantially horizontal position under suction, a light irradiator 57 for exposing the periphery of the substrate W held on the spin chuck 56 to light, and the like. The pair of edge exposure units EEW1 and EEW2 are arranged in vertically stacked relation in the center of the interface block 5. The transport robot TR4 provided adjacent to the edge exposure part EEW and the heat treatment tower 42 of the development processing block 4 is similar in construction to the above-mentioned transport robots TR1 to TR3.

As illustrated also in FIG. 2, a return buffer RBF for the return of substrates W is provided under the pair of edge exposure units EEW1 and EEW2, and the pair of vertically arranged substrate rest parts PASS9 and PASS10 are provided under the return buffer RBF. The return buffer RBF is provided to temporarily store a substrate W subjected to a post-exposure heating process in the heating parts PHP7 to PHP12 of the development processing block 4 if the development processing block 4 is unable to perform the development process on the substrate W because of some sort of malfunction and the like. The return buffer RBF includes a cabinet capable of storing a plurality of substrates W in tiers. The upper substrate rest part PASS9 is used for the transfer of a substrate W from the transport robot TR4 to the transport mechanism 55. The lower substrate rest part PASS10 is used for the transfer of a substrate W from the transport mechanism 55 to the transport robot TR4. The transport robot TR4 gains access to the return buffer RBF.

The transport mechanism 55 includes a movable base 55a movable horizontally in the Y direction, and a holding arm 55b mounted on the movable base 55a and for holding a substrate W, as illustrated in FIG. 2. The holding arm 55b is capable of moving vertically, pivoting and moving back and forth in the direction of the pivot radius relative to the movable base 55a. With such an arrangement, the transport mechanism 55 transfers and receives a substrate W to and from the exposure unit EXP, transfers and receives a substrate W to and from the substrate rest parts PASS9 and PASS10, and stores and takes a substrate W into and out of a send buffer SBF for the sending of substrates W. The send buffer SBF is provided to temporarily store a substrate W prior to the exposure process if the exposure unit EXP is unable to accept the substrate W, and includes a cabinet capable of storing a plurality of substrates W in tiers.

A downflow of clean air is always supplied into the indexer block 1, the BARC block 2, the resist coating block 3, the development processing block 4, and the interface block 5 described above to thereby avoid the adverse effects of raised particles and gas flows upon the processes in the respective blocks 1 to 5. Additionally, a slightly positive pressure relative to the external environment of the substrate processing apparatus is maintained in each of the blocks 1 to 5 to prevent the entry of particles and contaminants from the external environment into the blocks 1 to 5.

The indexer block 1, the BARC block 2, the resist coating block 3, the development processing block 4 and the interface block 5 as described above are units into which the substrate processing apparatus of this preferred embodiment is divided in mechanical terms. The blocks 1 to 5 are assembled to individual block frames, respectively, which are in turn connected together to construct the substrate processing apparatus.

On the other hand, this preferred embodiment employs another type of units, that is, transport control units regarding the transport of substrates, aside from the blocks which are units based on the above-mentioned mechanical division. The transport control units regarding the transport of substrates are referred to herein as “cells.” Each of the cells includes a transport robot responsible for the transport of substrates, and a transport destination part to which the transport robot is capable of transporting a substrate. Each of the above-mentioned substrate rest parts PASS1 to PASS10 functions as an entrance substrate rest part for the receipt of a substrate W into a cell or as an exit substrate rest part for the transfer of a substrate W out of a cell. The transfer of substrates W between the cells is carried out through the substrate rest parts. The transport robots constituting the cells include the substrate transfer mechanism 12 of the indexer block 1 and the transport mechanism 55 of the interface block 5.

The substrate processing apparatus in this preferred embodiment includes six cells: an indexer cell, a BARC cell, a resist coating cell, a development processing cell, a post-exposure bake cell, and an interface cell. The indexer cell includes the table 11 and the substrate transfer mechanism 12, and is consequently similar in construction to the indexer block 1 which is one of the units based on the mechanical division. The BARC cell includes the bottom coating processor BRC, the pair of heat treatment towers 21 and the transport robot TR1. The BARC cell is also consequently similar in construction to the BARC block 2 which is one of the units based on the mechanical division. The resist coating cell includes the resist coating processor SC, the pair of heat treatment towers 31, and the transport robot TR2. The resist coating cell is also consequently similar in construction to the resist coating block 3 which is one of the units based on the mechanical division.

The development processing cell includes the development processor SD, the heat treatment tower 41, and the transport robot TR3. Because the transport robot TR3 cannot gain access to the heating parts PHP7 to PHP12 and the cool plate CP14 of the heat treatment tower 42 as discussed above, the development processing cell does not include the heat treatment tower 42. In this respect, the development processing cell differs from the development processing block 4 which is one of the units based on the mechanical division.

The post-exposure bake cell includes the heat treatment tower 42 positioned in the development processing block 4, the edge exposure part EEW positioned in the interface block 5, and the transport robot TR4 positioned in the interface block 5. That is, the post-exposure bake cell extends over the development processing block 4 and the interface block 5 which are units based on the mechanical division. In this manner, constituting one cell including the heating parts PHP7 to PHP12 for performing the post-exposure heating process and the transport robot TR4 allows the rapid transport of exposed substrates W into the heating parts PHP7 to PHP12 for the execution of the heat treatment. Such an arrangement is preferred for the use of a chemically amplified resist which is required to be subjected to a heating process as soon as possible after the exposure of a substrate W in a pattern.

The substrate rest parts PASS7 and PASS8 included in the heat treatment tower 42 are provided for the transfer of a substrate W between the transport robot TR3 of the development processing cell and the transport robot TR4 of the post-exposure bake cell.

The interface cell includes the transport mechanism 55 for transferring and receiving a substrate W to and from the exposure unit EXP which is an external apparatus. The interface cell differs from the interface block 5 which is one of the units based on the mechanical division in that the interface cell does not include the transport robot TR4 and the edge exposure part EEW. The substrate rest parts PASS9 and PASS10 under the edge exposure part EEW are provided for the transfer of a substrate W between the transport robot TR4 of the post-exposure bake cell and the transport mechanism 55 of the interface cell.

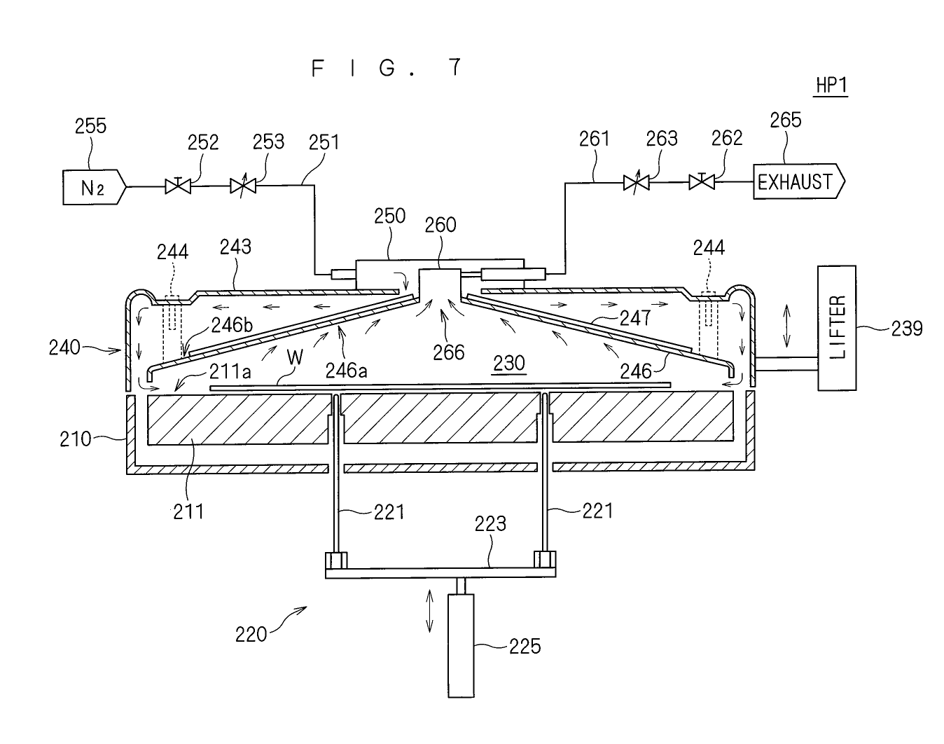

A control mechanism in the substrate processing apparatus of this preferred embodiment will be described. FIG. 6 is a schematic block diagram of the control mechanism. As shown in FIG. 6, the substrate processing apparatus of this preferred embodiment has a three-level control hierarchy composed of a main controller MC, cell controllers CC, and unit controllers. The main controller MC, the cell controllers CC and the unit controllers are similar in hardware construction to typical computers. Specifically, each of the controllers includes a CPU for performing various computation processes, a ROM or read-only memory for storing a basic program therein, a RAM or readable/writable memory for storing various pieces of information therein, a magnetic disk for storing control applications and data therein, and the like.

The single main controller MC at the first level is provided for the entire substrate processing apparatus, and is principally responsible for the management of the entire substrate processing apparatus, the management of a main panel MP, and the management of the cell controllers CC. The main panel MP functions as a display for the main controller MC. Various commands may be entered into the main controller MC from a keyboard KB. The main panel MP may be in the form of a touch panel so that a user performs an input process into the main controller MC from the main panel MP.

The cell controllers CC at the second level are individually provided in corresponding relation to the six cells (the indexer cell, the BARC cell, the resist coating cell, the development processing cell, the post-exposure bake cell, and the interface cell). Each of the cell controllers CC is principally responsible for the control of the transport of substrates and the management of the units in a corresponding cell. Specifically, the cell controllers CC for the respective cells send and receive information in such a manner that a first cell controller CC for a first cell sends information indicating that a substrate W is placed on a predetermined substrate rest part to a second cell controller CC for a second cell adjacent to the first cell, and the second cell controller CC for the second cell having received the substrate W sends information indicating that the substrate W is received from the predetermined substrate rest part back to the first cell controller CC. Such sending and receipt of information are carried out through the main controller MC. Each of the cell controllers CC provides the information indicating that a substrate W is transported into a corresponding cell to a transport robot controller TC, which in turn controls a corresponding transport robot to circulatingly transport the substrate W in the corresponding cell in accordance with a predetermined procedure. The transport robot controller TC is a controller implemented by the operation of a predetermined application in the corresponding cell controller CC.

Examples of the unit controllers at the third level include a spin controller and a bake controller. The spin controller directly controls spin units (the coating processing units and the development processing units) provided in a corresponding cell in accordance with an instruction given from a corresponding cell controller CC. Specifically, the spin controller controls, for example, a spin motor for a spin unit to adjust the number of revolutions of a substrate W. The bake controller directly controls the heat treatment units (the hot plates, the cool plates, the heating parts, and the like) provided in a corresponding cell in accordance with an instruction given from a corresponding cell controller CC. Specifically, the bake controller controls, for example, a heater incorporated in a hot plate to adjust a plate temperature and the like.

The coating processing units BRC1, BRC2 and BRC3 in the above-mentioned BARC block 2 are controlled by the spin controller in the BARC cell. The transport robot TR1 is controlled by the transport robot controller TC in the BARC cell, and the hot plates HP1 to HP6 are controlled by the bake controller in the BARC cell.

The host computer 100 connected via the LAN lines to the substrate processing apparatus ranks as a higher level control mechanism than the three-level control hierarchy provided in the substrate processing apparatus (see FIG. 1). The host computer 100 includes a CPU for performing various computation processes, a ROM or read-only memory for storing a basic program therein, a RAM or readable/writable memory for storing various pieces of information therein, a magnetic disk for storing control applications and data therein, and the like. The host computer 100 is similar in construction to a typical computer. Typically, a plurality of substrate processing apparatuses according to this preferred embodiment are connected to the host computer 100. The host computer 100 provides a recipe containing descriptions about a processing procedure and processing conditions to each of the substrate processing apparatuses connected to the host computer 100. The recipe provided from the host computer 100 is stored in a storage part (e.g., a memory) of the main controller MC of each of the substrate processing apparatuses.

The exposure unit EXP is provided with a separate controller independent of the above-mentioned control mechanism of the substrate processing apparatus. In other words, the exposure unit EXP does not operate under the control of the main controller MC of the substrate processing apparatus, but controls its own operation alone. Such an exposure unit EXP also controls its own operation in accordance with a recipe received from the host computer 100, and the substrate processing apparatus performs processes synchronized with the exposure process in the exposure unit EXP.

Next, the operation of the substrate processing apparatus of this preferred embodiment will be described. The control mechanism of FIG. 6 controls the parts in accordance with the descriptions of the recipe received from the host computer 100, whereby a procedure to be described below is executed.

First, unprocessed substrates W stored in a cassette C are transported from the outside of the substrate processing apparatus into the indexer block 1 by an AGV (automatic guided vehicle) and the like. Subsequently, the unprocessed substrates W are transferred outwardly from the indexer block 1. Specifically, the substrate transfer mechanism 12 in the indexer cell (or the indexer block 1) takes an unprocessed substrate W out of a predetermined cassette C, and places the unprocessed substrate W onto the substrate rest part PASS1. After the unprocessed substrate W is placed on the substrate rest part PASS1, the transport robot TR1 of the BARC cell uses one of the holding arms 6a and 6b to receive the unprocessed substrate W. The transport robot TR1 transports the received unprocessed substrate W to one of the coating processing units BRC1 to BRC3. In the coating processing units BRC1 to BRC3, the surface of the substrate W is spin-coated with the chemical solution serving as the coating solution for the formation of the anti-reflective film (in this preferred embodiment, the BARC). After the completion of the coating process, the transport robot TR1 transports the substrate W to one of the hot plates HP1 to HP6.

Description will be continued on the assumption that the substrate W spin-coated with the coating solution for the anti-reflective film is transported to the hot plate HP1. However, a procedure in which the substrate W is transported to the hot plates HP2 to HP6 is precisely identical with this procedure. When the transport robot TR1 transports the substrate W into the hot plate HP1, the cover 240 is moved up to the standby position shown in FIG. 8 by the lifter 239, and the three support pins 221 are moved down to the processing position shown in FIG. 7 so that the upper ends of the respective support pins 221 are hidden inside the heat treatment plate 211. In this state, the transport robot TR1 causes the holding arm 6a (or 6b) which holds the substrate W to move forward to over the heat treatment plate 211. Subsequently, the three support pins 221 are driven by the air cylinder 225 to move up to the standby position shown in FIG. 8 and to receive the substrate W from the transport robot TR1. After the transport robot TR1 causes the holding arm 6a to move backward out of the hot plate HP1, the three support pins 221 are moved down to the processing position by the air cylinder 225 to place the substrate W onto the holding surface 211a of the heat treatment plate 211. Also, the cover 240 is moved down to the processing position shown in FIG. 7 by the lifter 239. As a result, the heat treatment space 230 surrounded by the cover 240 and the heat treatment plate 211 is formed.

The temperature of the heat treatment plate 211 is previously increased to a predetermined temperature (in this preferred embodiment, 205° C.) under the control of the bake controller. The substrate W placed on the holding surface 211a of the heat treatment plate 211 is heated so that the temperature of the substrate W is increased to the above-mentioned plate temperature. This heating process volatilizes or sublimes a solvent and a resin component from the coating solution for the anti-reflective film to form the anti-reflective film on the substrate W by firing.

During the heating process (as shown in FIG. 7) in which the three support pins 221 and the cover 240 are moved down to the processing position, the nitrogen gas is supplied from the gas supply source 255 to the heat treatment space 230, and at the same time the atmosphere in the heat treatment space 230 continues to be discharged through the exhaust outlet 266 into the exhaust part 265. This produces a gas flow such that the nitrogen gas within the heat treatment space 230 passes near the peripheral portion of the heat treatment plate 211 toward the exhaust outlet 266. The sublimate produced from the coating solution for the anti-reflective film is carried by this nitrogen gas flow outwardly of the unit of the hot plate HP1.

In this preferred embodiment, the exhaust outlet 266 is formed in the upper central portion of the inner cover 246, and the inner wall surface 246a of the inner cover 246 is the tapered surface such as to flare out from the exhaust outlet 266 toward the heat treatment plate 211. This produces a smooth flow of nitrogen gas along the tapered surface to suppress the occurrence of a holdup of gas flow within the heat treatment space 230. As a result, the sublimate produced from the coating solution for the anti-reflective film is also smoothly discharged together with the gas flow outwardly through the exhaust port 260. Therefore, this preferred embodiment increases the efficiency of collection of the sublimate, and prevents the sublimate from adhering to an internal structure (e.g., the cover 240) of the hot plate HP1.

Also, the inner wall surface 246a of the inner cover 246 is a smooth surface (having an average surface roughness of not greater than 1.6 μm) formed by electrolytic polishing. This prevents the sublimate from adhering to the inner wall surface 246a more effectively.

Additionally, the heater 247 is affixed to the outer wall surface 246b of the inner cover 246. The inner cover 246 is heated to a predetermined temperature by the heater 247. This prevents the sublimate from being deposited and adhering to the inner wall surface 246a of the inner cover 246 more effectively. The temperature to which the inner cover 246 is heated by the heater 247 may be a temperature at which the deposition of the sublimate can be substantially suppressed.

As a result of the elimination of the holdup of gas flow within the heat treatment space 230 because of the use of the tapered surface as the inner wall surface 246a of the inner cover 246, convection within the heat treatment space 230 is also suppressed, whereby the within-wafer temperature distribution uniformity of the substrate W during the heating process is improved. Thus, even if the gas is supplied to and exhausted from the heat treatment space 230 at a higher flow rate than earlier, the within-wafer temperature distribution uniformity of the substrate W is prevented from being impaired. Table 1 below shows a correspondence between the flow rate of the exhaust gas from the exhaust outlet 266 and the within-wafer temperature distribution uniformity of a substrate on the conditions that the substrate for temperature measurement at 17 points on a main surface thereof is heated at 180° C. in the hot plate HP1 according to this preferred embodiment.

TABLE 1

| Exhaust Gas Flow Rate (liter/min.) | Range (° C.) |
|---|---|
| 5 | 0.72 |
| 10 | 0.96 |
| 20 | 1.58 |

In Table 1, the term “range” refers to a difference between the maximum value and the minimum value of the measured temperatures at the 17 points. It may be said that the smaller the range is, the better the within-wafer temperature distribution uniformity of the substrate is. For the conventional configuration such that the inner cover and the heat treatment plate are parallel to each other, the range was 1.59° C. even when the exhaust gas flow rate was one liter per minute. It is clear from this fact that the use of the tapered surface as the inner wall surface 246a of the inner cover 246 as in the hot plate HP1 according to this preferred embodiment ensures the within-wafer temperature distribution uniformity of the substrate as good as earlier even when the exhaust gas flow rate from the exhaust outlet 266 is 20 liters per minute. Thus, this preferred embodiment achieves a significant increase in the exhaust gas flow rate over the conventional configuration. The increase in the exhaust gas flow rate from the heat treatment space 230 allows the collection of the sublimate with higher reliability, to thereby prevent the sublimate from adhering to the inner wall surface 246a more effectively.

The hot plate HP1 according to this preferred embodiment is capable of collecting almost every sublimate through the exhaust outlet 266 at an exhaust gas flow rate of not less than five liters per minute to consequently sufficiently prevent the sublimate from adhering to the inner wall surface 246a. On the other hand, the level of requirements for the within-wafer temperature distribution uniformity of substrates during the heat treatment becomes more and more severe year by year, and it is desirable that the range is not greater than 1° C. To attain this, the exhaust gas flow rate should be not greater than ten liters per minute. In other words, when the exhaust gas flow rate at which the exhaust part 265 exhausts the gas from the heat treatment space 230 is in the range of five liters per minute to ten liters per minute, the sublimate is sufficiently prevented from adhering to the inner wall surface 246a of the inner cover 246 without impairing the within-wafer temperature distribution uniformity of the substrate W being heat-treated.

The firing process is completed at that point in time when the anti-reflective film is formed on the substrate W after a predetermined period of heat treatment time has elapsed during which the sublimate produced from the coating solution is effectively collected in a manner as described above. Then, the cover 240 moves up to the standby position, and the three support pins 221 also move up to the standby position. As the three support pins 221 move upwardly, the substrate W placed on the holding surface 211a of the heat treatment plate 211 is thrust up by the support pins 221 into a spaced apart relationship with the holding surface 211a, as shown in FIG. 8. As a result, the supply of heat to the substrate W supported by the three support pins 221 is stopped, so that the temperature of the substrate W starts decreasing gradually.

Immediately after the support pins 221 move up, the temperature of the substrate W is not sufficiently decreased, and the sublimate continues to be produced. Transporting the substrate W out of the hot plate HP1 immediately after the support pins 221 move up gives rise to apprehension that sublimate flies off in the transport space (or the space around the transport robot TR1) of the substrate processing apparatus to diffuse to the entire substrate processing apparatus, thereby contaminating the various parts of the substrate processing apparatus. When such a flying sublimate enters, for example, the development processing units SD1 to SD5, the sublimate causes a development defect as discussed above.

Table 2 below shows a relationship between a heating temperature and the amount of produced sublimate (the count of sublimate particles having a diameter of not less than 0.1 μm) when a substrate W coated with a coating solution for the formation of an anti-reflective film is processed at a specified processing temperature for a specified period of processing time and is thereafter further heated. A large amount of sublimate is produced from the anti-reflective film at 205° C. which is a firing processing temperature according to this preferred embodiment, and it is found that a slight amount of sublimate is produced even at 200° C. On the other hand, it is found that no sublimate is produced at a heating temperature of not greater than 190° C.

TABLE 2

| | Temperature (° C.) | | | | | | |
|---|---|---|---|---|---|---|---|
| | 120 | 140 | 160 | 180 | 190 | 200 | 205 |
| Count | 0 | 0 | 0 | 0 | 0 | 1448 | 44773 |

Thus, the transport robot TR1 transports the substrate W out of the hot plate HP1 in this preferred embodiment at that point in time when the temperature of the substrate W subjected to the heating process by the heat treatment plate 211 in the heat treatment space 230 and then thrust up from the holding surface 211a by the thrusting-up mechanism 220 is decreased down to 190° C. or lower. Specifically, the time required for the temperature of the substrate W to reach 190° C. or lower after the support pins 221 move up is previously measured by experiment or in simulation, and the transport robot controller TC controls the transport robot TR1 to transport the substrate W out of the hot plate HP1 after the measured time has elapsed since the support pins 221 moved up. In this preferred embodiment, the transport robot TR1 transports the substrate W out of the hot plate HP1 after 20 seconds have elapsed since the support pins 221 moved up.

This prevents the sublimate from flying off through the transport space to the entire substrate processing apparatus because no sublimate is produced from the substrate W when the substrate W is transported out of the hot plate HP1.

However, the sublimate continues to be still produced during the time interval between the moving up of the three support pins 221 and the transport of the substrate W out of the hot plate HP1. For this reason, the gas supply source 255 continues to supply the nitrogen gas and the exhaust part 265 continues to exhaust the gas, whereby the produced sublimate is collected by and discharged through the exhaust outlet 266. The shutter of the enclosure of the hot plate HP1 remains closed while the substrate W is in a standby condition until the temperature of the substrate W is decreased to 190° C. or lower after the moving up of the support pins 221. This prevents the sublimate produced during the standby condition from leaking out of the hot plate HP1.

The procedure in which the transport robot TR1 transports the substrate W out of the hot plate HP1 is the reverse of the above-mentioned procedure in which the transport robot TR1 transports the substrate W into the hot plate HP1. Specifically, the transport robot TR1 causes the holding arm 6a (or 6b) to move forward to under the substrate W supported by the support pins 221. Next, the three support pins 221 move down to the processing position to pass the substrate W to the holding arm 6a. Thereafter, the transport robot TR1 causes the holding arm 6a to move backward out of the hot plate HP1. This completes the transport of the substrate W out of the hot plate HP1.

Since the substrate W transported out of the hot plate HP1 is not cooled down to a degree sufficient for the next step (the resist coating step), the transport robot TR1 transports the substrate W to one of the cool plates CP1 to CP3, which in turn cools down the substrate W. In this step, the cool plate WCP may be used to cool down the substrate W. The transport robot TR1 places the cooled substrate W onto the substrate rest part PASS3.

A dehydration process may be performed prior to the application of the coating solution for the anti-reflective film. In this case, the transport robot TR1 transports the unprocessed substrate W placed on the substrate rest part PASS1 first to one of the adhesion promotion processing parts AHL1 to AHL3. In the adhesion promotion processing parts AHL1 to AHL3, a heating process (dehydration bake) merely for dehydration is performed on the substrate W without supplying the vapor atmosphere of HMDS. The transport robot TR1 takes out the substrate W subjected to the heating process for dehydration, and transports the substrate W to one of the cool plates CP1 to CP3, which in turn cools down the substrate W. The transport robot TR1 transports the cooled substrate W to one of the coating processing units BRC1 to BRC3. In the coating processing units BRC1 to BRC3, the substrate W is spin-coated with the coating solution for the anti-reflective film. Thereafter, the transport robot TR1 transports the substrate W to one of the hot plates HP1 to HP6. In the hot plates HP1 to HP6, the heating process is performed on the substrate W to form the anti-reflective film (the BARC) serving as the undercoat on the substrate W. The operation of the hot plates HP1 to HP6 at this time is similar to that described above. Thereafter, the transport robot TR1 takes the substrate W from the hot plate, and transports the substrate W to one of the cool plates CP1 to CP3, which in turn cools down the substrate W. Then, the transport robot TR1 places the cooled substrate W onto the substrate rest part PASS3.

After the substrate W is placed on the substrate rest part PASS3, the transport robot TR2 in the resist coating cell receives the substrate W, and transports the substrate W to one of the coating processing units SC1 to SC3. In the coating processing units SC1 to SC3, the substrate W with the anti-reflective film formed thereon is spin-coated with the resist. Because the resist coating process requires precise substrate temperature control, the substrate W may be transported to one of the cool plates CP4 to CP9 immediately before being transported to the coating processing units SC1 to SC3.

After the completion of the resist coating process, the transport robot TR2 transports the substrate W to one of the heating parts PHP1 to PHP6. In the heating parts PHP1 to PHP6, the heating process performed on the substrate W removes a solvent component from the resist to form a resist film on the substrate W. Thereafter, the transport robot TR2 takes the substrate W from the one of the heating parts PHP1 to PHP6, and transports the substrate W to one of the cool plates CP4 to CP9, which in turn cools down the substrate W. Then, the transport robot TR2 places the cooled substrate W onto the substrate rest part PASS5.

After the substrate W with the resist film formed thereon by the resist coating process is placed on the substrate rest part PASS5, the transport robot TR3 in the development processing cell receives the substrate W, and places the substrate W onto the substrate rest part PASS7 without any processing of the substrate W. Then, the transport robot TR4 in the post-exposure bake cell receives the substrate W placed on the substrate rest part PASS7, and transports the substrate W to one of the edge exposure units EEW1 and EEW2. In the edge exposure units EEW1 and EEW2, a peripheral edge portion of the substrate W is exposed to light. The transport robot TR4 places the substrate W subjected to the edge exposure process onto the substrate rest part PASS9. The transport mechanism 55 in the interface cell receives the substrate W placed on the substrate rest part PASS9, and transports the substrate W into the exposure unit EXP. The substrate W transported into the exposure unit EXP is subjected to the pattern exposure process. Because the chemically amplified resist is used in this preferred embodiment, an acid is formed by a photochemical reaction in the exposed portion of the resist film formed on the substrate W. The substrate W subjected to the edge exposure process may be transported into the cool plate CP14 by the transport robot TR4 and subjected to a cooling process therein before being transported to the exposure unit EXP.

The exposed substrate W subjected to the pattern exposure process is transported from the exposure unit EXP back to the interface cell again. The transport mechanism 55 places the exposed substrate W onto the substrate rest part PASS10. After the exposed substrate W is placed on the substrate rest part PASS10, the transport robot TR4 in the post-exposure bake cell receives the substrate W, and transports the substrate W to one of the heating parts PHP7 to PHP12. In the heating parts PHP7 to PHP12, the post-exposure heating process (post-exposure bake) is performed which causes reactions such as crosslinking, polymerization and the like of the resist resin to proceed by using a product formed by the photochemical reaction during the exposure process as an acid catalyst, thereby locally changing the solubility of only the exposed portion of the resist resin in the developing solution. The local transport mechanism (the transport mechanism in the one of the heating parts PHP7 to PHP12; see FIG. 1) having a cooling mechanism transports the substrate W subjected to the post-exposure bake process to thereby cool the substrate W, whereby the above-mentioned chemical reaction stops. Subsequently, the transport robot TR4 takes the substrate W from the one of the heating parts PHP7 to PHP12, and places the substrate W onto the substrate rest part PASS8.

After the substrate W is placed on the substrate rest part PASS8, the transport robot TR3 in the development processing cell receives the substrate W, and transports the substrate W to one of the cool plates CP10 to CP13. In the cool plates CP10 to CP13, the substrate W subjected to the post-exposure bake process is further cooled down and precisely controlled at a predetermined temperature. Thereafter, the transport robot TR3 takes the substrate W from the one of the cool plates CP10 to CP13, and transports the substrate W to one of the development processing units SD1 to SD5. In the development processing units SD1 to SD5, the developing solution is applied onto the substrate W to cause the development process to proceed. After the completion of the development process, the transport robot TR3 transports the substrate W to one of the hot plates HP7 to HP11, and then transports the substrate W to one of the cool plates CP10 to CP13.

Thereafter, the transport robot TR3 places the substrate W onto the substrate rest part PASS6. The transport robot TR2 in the resist coating cell transfers the substrate W from the substrate rest part PASS6 onto the substrate rest part PASS4 without any processing of the substrate W. Next, the transport robot TR1 in the BARC cell transfers the substrate W from the substrate rest part PASS4 onto the substrate rest part PASS2 without any processing of the substrate W, whereby the substrate W is stored in the indexer block 1. Then, the substrate transfer mechanism 12 in the indexer cell stores the processed substrate W held on the substrate rest part PASS2 into a predetermined cassette C. Thereafter, the cassette C in which a predetermined number of processed substrates W are stored is transported to the outside of the substrate processing apparatus. Thus, a series of photolithography processes are completed.

With the above-mentioned arrangement, the inner wall surface 246a of the inner cover 246 in the hot plate HP1 is the tapered surface such as to flare out from the exhaust outlet 266 toward the heat treatment plate 211. Thus, the gas within the heat treatment space 230 smoothly flows along the tapered surface toward the exhaust outlet 266, and the sublimate produced from the coating solution for the anti-reflective film is smoothly discharged together with the gas flow outwardly through the exhaust outlet 266. Therefore, this preferred embodiment is capable of sufficiently collecting the sublimate to suppress the adhesion of the sublimate to the internal structure of the hot plate HP1.

Additionally, after the completion of the heating process in the hot plate HP1, the substrate W is placed in a standby condition within the hot plate HP1 until the substrate temperature is decreased to at least the temperature at which the production of the sublimate from the anti-reflective film formed by firing on the substrate W stops, and thereafter the transport robot TR1 transports the substrate W out of the hot plate HP1. Thus, no sublimate is produced from the substrate W at the time of transport of the substrate W out of the hot plate HP1. This prevents the sublimate from flying off to the outside of the hot plate HP1 and diffusing through the transport space to the entire substrate processing apparatus. Consequently, this preferred embodiment is capable of preventing the occurrence of various troubles resulting from the flying-off of the sublimate, e.g. a development defect.

Although the preferred embodiment according to the present invention has been described hereinabove, various modifications in addition to the above may be made without departing from the spirit and scope of the present invention. In the above-mentioned preferred embodiment, for example, the surface of the substrate W is coated with the coating solution for the formation of the anti-reflective film (in this preferred embodiment, the BARC) in the coating processing units BRC1 to BRC3, and the substrate W is then heated in the hot plates HP1 to HP6, whereby the anti-reflective film is formed by firing on the substrate W. An alternative technique may be employed which includes coating the surface of the substrate W with a coating solution for the formation of a spin-on-carbon film (an SOC film), and heating the substrate W in the hot plates HP1 to HP6, thereby forming the SOC film by firing on the substrate W. The SOC film is developed as an etching mask adaptable to the recent fine patterning process, and is a carbon hard mask formed under the resist film. Characteristics of the SOC film are a low reflectivity and high resistance to etching.

The process for forming the SOC film having such characteristics includes coating the surface of the substrate W with a coating solution for the formation of the SOC film by using a technique similar to that for the above-mentioned anti-reflective film, and heating the substrate W to remove components other than carbon by firing, thereby forming a carbon film with the minimum content of impurities. Depending on the type of the chemical solution used, the firing processing temperature of the SOC film is generally higher than the firing processing temperature of the anti-reflective film (the BARC). The removal of the components other than carbon during the firing process of the SOC film results in the production of a greater amount of sublimate (than that produced during the formation of the anti-reflective film by firing).

Table 3 below shows a relationship between a heating temperature and the amount of produced sublimate (the count of sublimate particles having a diameter of not less than 0.1 μm) when a substrate W coated with a chemical solution for the formation of an SOC film is processed at a specified processing temperature (220° C.) for a specified period of processing time (60 seconds) and is thereafter further heated. A large amount of sublimate is produced from the SOC film at 220° C. which is the firing processing temperature of the chemical solution for this SOC film, and it is found that a slight amount of sublimate is produced even at 210° C. On the other hand, it is found that no sublimate is produced at a heating temperature of not greater than 200° C.

TABLE 3

| | Temperature (° C.) | | | | | | |
|---|---|---|---|---|---|---|---|
| | 160 | 170 | 180 | 190 | 200 | 210 | 220 |
| Count | 0 | 0 | 0 | 0 | 1 | 4566 | 1569688 |

Thus, in the case of the execution of the firing process of the SOC film, the transport robot TR1 transports the substrate W out of the hot plate HP1 at that point in time when the temperature of the substrate W subjected to the heating process by the heat treatment plate 211 and then thrust up from the holding surface 211a by the thrusting-up mechanism 220 is decreased down to 200° C. or lower. Specifically, the time required for the temperature of the substrate W to reach 200° C. or lower after the support pins 221 move up is previously measured by experiment or in simulation, and the transport robot controller TC controls the transport robot TR1 to transport the substrate W out of the hot plate HP1 after the measured time has elapsed since the support pins 221 moved up.

This prevents the sublimate from flying off through the transport space to the entire substrate processing apparatus because no sublimate is produced from the substrate W when the substrate W is transported out of the hot plate HP1 also in the case of the execution of the process of forming the SOC film on the substrate W.

The substrate processing technique according to the present invention is effective for various coatings on the substrate which produce a large amount of sublimate during the heating process, and may be satisfactorily used not only for the above-mentioned anti-reflective and SOC films but for a photoresist film which produces a large amount of sublimate during the heating process, a color resist film used for a color filter, and the like. After the completion of the heating process, the substrate W may be placed in a standby condition within the hot plate HP1 until the substrate temperature is decreased down to at least the temperature at which the production of the sublimate from the film formed by firing on the substrate W stops, and thereafter the transport robot TR1 may transport the substrate W out of the hot plate HP1, whereby the sublimate is prevented from flying off in the substrate processing apparatus. In other words, the technique according to the present invention is applicable to any predetermined film formed by coating the substrate W with a chemical solution which produces a sublimate when heated and then heating the substrate W. The heating process temperature in the hot plate HP1 and the temperature used when the substrate W is transported out of the hot plate HP1 are set as appropriate depending on the type of the chemical solution for coating on the substrate W.

In the above-mentioned preferred embodiment, the inner wall surface 246a of the inner cover 246 is mirror-finished by electrolytic polishing. Alternatively, the inner wall surface 246a may be coated with a material (e.g., fluoroplastic) having a low surface free energy. This also makes it difficult for the sublimate to adhere to the inner wall surface 246a, thereby preventing the adhesion of the sublimate more effectively.

In the above-mentioned preferred embodiment, a silicone rubber heater serving as the heater 247 is affixed to the outer wall surface 246b of the inner cover 246 to heat the inner cover 246. In place of or in addition to this, various mechanisms may be employed which prevent the decrease in the temperature of the inner cover 246. As an example, a thermal insulation member may be provided between the inner cover 246 and the outer cover 243 to lessen the heat dissipation from the inner cover 246. Also, a heating mechanism for heating the entire cover 240 including the exhaust port 260 may be additionally provided.

The thrusting-up mechanism 220 thrusts up the substrate W subjected to the heating process for a predetermined period of time from the holding surface 211a to establish a spaced apart relationship between the substrate W and the holding surface 211a in the above-mentioned preferred embodiment. The present invention, however, is not limited to this, but other techniques may be used to space the substrate W apart from the holding surface 211a. For example, a purpose-built hand for spacing the substrate W subjected to the heating process apart from the holding surface 211a may be provided within the hot plate HP1.

The transport robot TR1 transports the substrate W out of the hot plate HP1 after the predetermined standby time has elapsed since the support pins 221 moved up in the above-mentioned preferred embodiment. To make the standby time as short as possible, the process of forcibly cooling down the substrate W supported by the support pins 221 may be performed to improve a cooling rate. An example of such a process includes increasing the exhaust gas flow rate from the exhaust outlet 266 up to 20 to 30 liters per minute to produce a high-rate gas flow around the substrate W supported by the support pins 221, thereby improving the cooling rate. Another example of such a process includes providing a cooling gas discharge nozzle in a lower peripheral portion of the cover 240 to blow a nitrogen gas for cooling, a helium gas having a high thermal conductivity and the like toward the periphery of the substrate W supported by the support pins 221, thereby improving the cooling rate. A still another example of such a process includes providing a port for exhausting the gas in a side surface of the hot plate HP1 in addition to the exhaust port 260 to locally exhaust the gas through the port provided in the side surface. A still more another example of such a process includes decreasing the substrate W to a predetermined temperature by the above-mentioned purpose-built hand for spacing the substrate W subjected to the heating process apart from the holding surface 211a, and then transferring the substrate W to the transport robot TR1. The “purpose-built hand” in this example shall be subjected to various types of surface preparation such as Teflon® coating for preventing the adhesion of a sublimate. These techniques may be performed alone or in combination to improve the cooling rate of the substrate W after the moving up of the support pins 221. This allows the temperature of the substrate W to decrease down to the temperature at which no sublimate is produced in a shorter period of time than the above-mentioned preferred embodiment, thereby shortening the standby time before the transport of the substrate W to the outside and improving processing efficiency.

In the above-mentioned preferred embodiment, the mica heater is used as the heat treatment plate 211 of the hot plate HP1. The heat treatment plate 211 of the hot plate HP1, however, is not limited to the mica heater, but may be, for example, a plate having a heat pipe structure.

The gas supplied from the gas supply source 255 is not limited to the nitrogen gas, but other inert gases such as argon gas, helium gas and the like may be supplied. In the light of costs, however, the nitrogen gas is preferably used.

The substrate to be processed by the substrate processing apparatus according to the present invention is not limited to a semiconductor wafer, but may include a glass substrate for a liquid crystal display device.

The construction of the substrate processing apparatus according to the present invention is not limited to the configuration shown in FIGS. 1 through 4. However, various modifications may be made to the substrate processing apparatus if the substrate processing apparatus forms a coating film which produces a large amount of sublimate.

While the invention has been described in detail, the foregoing description is in all aspects illustrative and not restrictive. It is understood that numerous other modifications and variations can be devised without departing from the scope of the invention.

1.-13. (canceled)

14. A substrate processing method for performing a film formation process on a substrate, comprising the steps of: coating a substrate with a chemical solution in a coating processing part; transporting the substrate coated with said chemical solution from said coating processing part to a heating part; placing the substrate coated with said chemical solution on a holding surface of a heat treatment plate within said heating part and heating the substrate to thereby form a film by firing on the substrate; spacing the substrate subjected to the heating process by said heat treatment plate apart from said holding surface; placing the substrate in a standby condition within said heating part until the temperature of the substrate spaced apart from said holding surface is decreased down to at least a predetermined temperature; and transporting the substrate the temperature of which is decreased down to at least said predetermined temperature out of said heating part.

15. The substrate processing method according to claim 14, wherein said chemical solution is a liquid producing a sublimate when heated by said heat treatment plate, and said predetermined temperature is a temperature at which the production of the sublimate from the film formed by firing on the substrate stops.

16. The substrate processing method according to claim 15, wherein said chemical solution is a coating solution for the formation of an anti-reflective film, and the substrate coated with said coating solution is heated, whereby the anti-reflective film is formed by firing on the substrate.

17. The substrate processing method according to claim 15, wherein said chemical solution is a coating solution for the formation of a spin-on-carbon film, and the substrate coated with said coating solution is heated, whereby the spin-on-carbon film is formed by firing on the substrate.
